(19) United States
(12) Patent Application Publication
(10) Pub. No.: US 2019/0385449 A1
(43) Pub. Date: Dec. 19, 2019

(54) SYSTEM AND METHOD FOR PROVIDING AUTOMATIC ON-STREET PARKING CONTROL AND UNOCCUPIED PARKING SPOT AVAILABILITY DETECTION

(71) Applicant: CHRISTOS PATEROPOULOS, Glyfada (GR)

(72) Inventor: CHRISTOS PATEROPOULOS, Glyfada (GR)

(21) Appl. No.: 16/439,373

(22) Filed: Jun. 12, 2019

Related U.S. Application Data
(60) Provisional application No. 62/684,374, filed on Jun. 13, 2018.

(51) Int. Cl. G08G 1/04; G08G 1/052; G08G 1/065; G08G 1/14; G06Q 30/02

(52) U.S. Cl. CPC G08G 1/04; G08G 1/052; G06K 7/10297; G08G 1/14; G06Q 30/0284; G08G 1/065

(57) ABSTRACT

According to an exemplary embodiment, there may be provided an automatic on-street parking control and parking spot availability detection system and the corresponding method. The system works with identifying a vehicle entering and leaving a street segment and counting the time it spent within the street segment. A street segment may be defined by segment limits arranged on the ends of the street segment. Smart nodes may be provided at the segment limits in order to monitor and/or identify the vehicles passing by and crossing the segment limit.

### CROSS-REFERENCE TO RELATED APPLICATION

The present application is based on provisional application Ser. No. 62/684,374, filed Jun. 13, 2018, the entire contents of which are herein incorporated by reference.

### TECHNICAL FIELD

The present disclosure relates to on-street parking control and, more specifically, to a system and method for providing automatic on-street parking control and unoccupied parking spot availability detection.

### DISCUSSION OF THE RELATED ART

Parking management and enforcement are nowadays in the core of smart cities. Revenue from parking is becoming a major source of income for cities to fund their local activities and investment plans and to lower citizens' taxation. As a result, cities are trying to optimize the parking enforcement solutions, so as to make the best out of their human resources and maximize the efficiency of their teams in terms of street coverage, man-hours and human error minimization. These efforts are often related to smart city infrastructures, such as smart on-street parking systems.

As increasing number of cars flood the roadways, locating a vacant parking space has become problematic for many people on a daily basis. Difficulties in finding an available parking spot require drivers to undertake prolonged searching, thus resulting in increased air and sound pollution, traffic, accidents, reduction of productivity and lots of lost man-hours.

Therefore, it is desirable for the parking management and enforcement systems to not only provide insights to the parking enforcement authorities, but also to help motorists find vacant parking spaces. Eliminating parking search can reduce city traffic up to a reported value of 30%, leading to direct significant environmental and economic benefits.

At present, payment for on-street parking is mostly done through online applications with the use of a handheld device, by paying at a parking meter, or by buying a prepaid parking card with fixed duration validity from local stores. Under these systems, motorists often have to identify their vehicles by online means (e.g., handheld device payment apps), or by entering and/or declaring their license plate numbers at the parking meter, which is tedious especially for the elderly or people with limited skills for utilizing technology. The experience can be more stressful because motorists need to act and pay again in case of an extended stay. Having the license plate numbers entered helps parking enforcement officers easily identify whether a vehicle is parked in a street without paying. However, the officers, while in duty, do need to scan all the driving plates in each street, or use other expensive solutions such as cars equipped with cameras having automatic vehicle recognition capabilities. The efficiency of those systems depends heavily on the re-visit rate (e.g. how often a street is checked) and the rate of mistake the personnel makes. On the other hand, an automatic payment and parking enforcement system could increase the efficiency of parking enforcement teams to the maximum by practically 1) setting the re-visit time to zero, 2) minimizing any human mistakes, and 3) maximizing the coverage area.

Most on-street smart parking systems work with the principle of single parking spot occupancy/release detection. One disadvantage here is that the number of the single parking spot occupancy sensors increases in proportion to the length of the street and that this number increases further in case of non-delineated or non-slotted parking spots. At the same time, such sensors typically need to be embedded in the asphalt, which is a tedious and lengthy activity. An alternative solution involves the use of video cameras mounted at elevated positions at the side of a street which may detect more than one spot at a time. This solution though is sensitive to physical obstacles such as tall vehicles or trees and has high installation and maintenance cost given the big numbers of cameras needed in order to improve accuracy. Furthermore, those on-street smart parking systems provide only parking spot occupancy information but not any vehicle identification. Because of this limitation, the implementation of a fully automatic payment system is not possible.

### SUMMARY

According to an exemplary embodiment, there may be provided an automatic on-street parking control and parking spot availability detection system and the corresponding method. The system works with identifying a vehicle entering and leaving a street segment and counting the time it spent within the street segment. A street segment may be defined by segment limits arranged on the ends of the street segment. Smart nodes may be provided at the segment limits in order to monitor and/or identify the vehicles passing by and crossing the segment. In determining when the vehicle has exited the street segment, e.g. crossed the segment limit, the system may process and use data originating from the installed sensors, from other installed infrastructure such as a parking meter, from mobile or handheld device and or from vehicles.

When a smart node identifies a vehicle entering the street segment, the time and date of that event may be logged. Subsequently, when a subsequent smart node identifies the same vehicle leaving the street segment, the exit time and date may be logged as well. By detecting the entrance and exit of the vehicle, the system may calculate the total time the vehicle has spent in the street segment and charge it accordingly.

A method for automated on-street parking control includes determining a traffic flow through a street segment using a first sensor disposed at a first end of the street segment and/or a second sensor disposed at a second end of the street segment, the second end being an opposite end to the first end. A time that a vehicle enters the street segment is determined using the first sensor and/or the second sensor. The vehicle is identified using the first sensor and/or the second sensor. A time that the vehicle exits the street segment is identified using the first sensor and/or the second sensor and calculating an elapsed time as a difference between the determined time that the vehicle exits the street segment and the determined time that the vehicle enters the street segment. A threshold time that is dependent upon the traffic flow through the street segment is determined such that as the traffic flow through the street segment is faster, the threshold time is shorter. It is determined whether the elapsed time exceeds the threshold time and a fee is assessed only when the elapsed time exceeds the threshold time, a value of the assessed fee being proportional to the elapsed time.

A method for automated street tolling includes determining a time that a vehicle enters a street segment using a first sensor disposed at a first end of the street segment and/or a second sensor disposed at a second end of the street segment. The vehicle is identified using the first sensor and/or the second sensor. A time that the vehicle exits the street segment is determined using the first sensor and/or the second sensor and an elapsed time is calculated as a difference between the determined time that the vehicle exits the street segment and the determined time that the vehicle enters the street segment. A fee is assessed for time spent within the street segment according to the elapsed time.

A method for automated on-street parking control includes receiving, at a central server, a parking request from a mobile device/electronic apparatus controlled by a user concerning a specified period of time and a specific vehicle. A payment request is sent back to the mobile device/electronic apparatus based on the specified period of time and the specified vehicle. Payment from the mobile device/electronic apparatus is received in response to the payment request. These communication and payment request and any payment handling may be processed via electronic apparatuses such as an electronic parking meter, a handheld or mobile device or the telematics system of a vehicle or by means of wired or mobile/wireless communication. A time that a vehicle of the user enters a street segment is determined using a first sensor disposed at a first end of the street segment and/or a second sensor disposed at a second end of the street segment, the second end being an opposite end to the first end. A time that the vehicle exits the street segment is determined using the first sensor and/or the second sensor and calculating an elapsed time as a difference between the determined time that the vehicle exits the street segment and the determined time that the vehicle enters the street segment. It is determined whether the elapsed time exceeds the specified period of time. A fine is assessed to the vehicle's owner, and/or a notification of a fine is sent to the vehicle's owner only when the elapsed time exceeds the specified period of time. Alternatively, the user may issue a parking payment request without specifying a time/duration but by specifying a monetary amount. In this case the above fine is issued if the elapsed time corresponds to a total payment greater than what was paid by the user.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exemplary embodiment of an on-street parking system applied in six one-way city streets;

FIG. 2 is an exemplary embodiment of the components of a smart node;

FIG. 3 is an exemplary embodiment of the on-street parking system applied in a street segment;

FIG. 4 is an exemplary arrangement of the smart nodes for a crossroad with four streets;

FIG. 5 is an exemplary illustration of a same one-way street at different time points t1, t2, and t3;

FIG. 6 is another exemplary illustration of a same one-way street at different time points t1, t2, and t3;

FIG. 7 is another exemplary illustration of a same one-way street at different time points t1, t2, and t3;

FIG. 8 is an exemplary embodiment of the on-street parking system applied in a two-way street;

FIG. 9 is an exemplary flowchart for a method providing on-street parking payment solutions and unoccupied parking spot availability detection;

FIG. 10 is an exemplary simplified flowchart for the method providing on-street parking payment solutions and unoccupied parking spot availability detection;

FIG. 11 is an exemplary flowchart for the subprocess of street segment occupancy detection and charges calculation;

FIG. 12 is an exemplary state diagram for available parking spot indication; and

FIG. 13 is an exemplary illustration showing the user/sensor/system interactions of the invented system.

### DETAILED DESCRIPTION OF THE DRAWINGS

in describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

As used herein, the term “street” may be defined as the space between building blocks of a city where there is a vehicle circulation. A street may have a specific length and a maximum allowed speed for vehicles that drive therethrough.

In order to simplify the identification and counting of vehicles, a street may be divided into two or more street segments. The term “street segment” may be defined as any part of a street or of a path of any length that does not have a pathway leading to off-street parking facilities, entrance or exit of a parking facility, or a junction to another road or a path or any kind of exit route for a vehicle towards private facilities or public infrastructure where access is not controlled/monitored by means of a smart node or a sensor. In absence of any parking facility and of any junction, the street segment may be as long as the whole length of the street. Also, two or more street segments may be merged, provided that the identification and counting of vehicles would not be compromised. This might even result to an area formed from a plurality of adjoint street segments.

It is to be understood, however, that a street may be a segment of roadway whose primary purpose is that of a thoroughfare used to allow for vehicular navigation therethrough. It is further understood that a street may have parking thereon, for examples, in the shoulders of the street that run along the sides of the driving lanes. While it may be less common, some streets may have parking between driving lanes. However, in all cases, a street must have at least one driving lane whose primary purpose is for vehicles to pass therethrough for some purpose other than entering or exiting a parking space. In contrast, a parking lot or parking garage is an area that is not a thoroughfare and serves no purpose for permitting vehicles to pass therethrough other than to enter, exit or navigate to an available parking space within the parking lot or parking garage.

At each end of a street segment there may be a segment limit. The term “segment limit” may be defined as point of entrance or exit to a street segment. The length of the street segment may be defined by a pair of segment limits.

It is to be further understood that an end to one street segment may be considered a beginning of another street segment, with the terms “end” and “beginning” being used interchangeably herein. However, in some instances a street segment may terminate with a dead end though which vehicles may not pass.

As exemplary embodiments of the present invention may relate to the billing of a driver/owner of a vehicle for time spent parked within a roadway, it is to be understood that, as used herein, the phrase “charging a vehicle” relates to an assessment of monetary fees to the driver/owner of the vehicle in exchange for the time spent parked within the roadway, or for just using the roadway, and this phrase is not intended to relate to the electrical recharging of batteries for electric and hybrid vehicles.

It is to further understood that when it comes to parking payments the words “driver”, “owner”, “motorist” and “user” are being used interchangeably herein. In most of the cases they only mean to specify the person that initiated the payment for a specific vehicle that corresponded to a specific parking event. This person may be the driver of a vehicle, a passenger or any other person. On the other hand, when it comes to parking fines and penalties or fees for using a street, they are associated to a vehicle and or the vehicle's owner and not to the person that may have initiated a payment.

Each segment limit may be provided with a smart node. The smart node may be a device that may identify vehicles entering and/or leaving a defined street segment. Identification of vehicles may be performed by using a sensor integrated in the smart node. The sensor may use one or a combination of the following manners to identify vehicles, however it is noted that the present invention is not so limited and other approaches may be utilized: Radio Frequency Identification (RFID) techniques, video processing, telematics, mobile and wireless data communication services, and vehicle to infrastructure communication. Any data received from the vehicle via one of the above methods may include information such as but not only limited to the identification of the vehicle, geo-location data and vehicle status information and may change the system data and the system state. The identification of a vehicle may have various dimensions such as, but not limited to, the vehicle's driving plate, brand, model, color, shape, height, width, and length. Typically, when a vehicle traverses one street segment from segment limit SL1 to segment limit SL2, the vehicle is being identified a) entering the street segment from the smart node at segment limit SL1, and b) leaving the smart segment from the smart node at segment limit SL2. In case of a U-turn within a street segment, the same smart node may detect the entrance and the exit of the vehicle from the street segment.

The sensor may also carry out vehicle counting capabilities. It may use one or a combination of the following techniques to count vehicles, but not only limited to: computer vision, radar sensing, laser sensing (Light Detection and Ranging (LIDAR)), magnetic sensing, acoustic sensing, infrared sensing, inductive loop, pneumatic road tubes, and piezoelectric cables. Besides vehicle identification and counting, the sensor may also provide various other measurements, including but not only limited to the vehicles' rate of entry and exit in and out of a street segment respectively. It is to be further understood that although the word “sensor” may refer to one building element of the smart node, it is also being used interchangeably herein with the term “smart node”.

Alternatively, the vehicle counting and measuring capacities may be performed by a microprocessor that may be integrated within the smart node and analyze the data from the sensor.

According to at least one exemplary embodiment, a method and a system for providing on-street parking payment and unoccupied parking spot availability detection may be shown and disclosed. When a smart node identifies a vehicle entering a street segment, the time and date of that event may be logged. Subsequently, when a subsequent smart node identifies the same vehicle leaving the street segment, the exit time and date may be logged as well. By detecting the entrance and exit of the vehicle, the system may calculate the total time the vehicle has spent parked in the street segment and charge a registered user or owner of the vehicle accordingly. Payments may be done seamlessly via an automatic payment system where the users need to sign up in advance and associate their account with a vehicle. Alternatively, the users may employ other forms of payment such as but not only limited to: the use of a parking meter, via mobile or handheld devices, via the telematic services of a vehicle or via online payments. In this case any paid amount and or the specified parking time is compared with the calculated parking fee and or with the calculated parking time respectively and in case of a mismatch, a fine may be issued. This fine or citation or Penalty Charge Notice (PCN) may be sent to the user and or to an appropriate authority in charge of the parking fines.

A fee may be further calculated for using the street. Based on calculations such as these, the system may issue a fine or charge automatically the account of a registered user or the owner of the vehicle accordingly. Payments and/or charging of the account corresponding to a vehicle may be done seamlessly via an automatic payment system where the users need to sign up in advance and associate their account with a vehicle. Alternatively, a fine or a fine notice for using the street may be sent to the user and or to an appropriate authority in charge of the street usage fees.

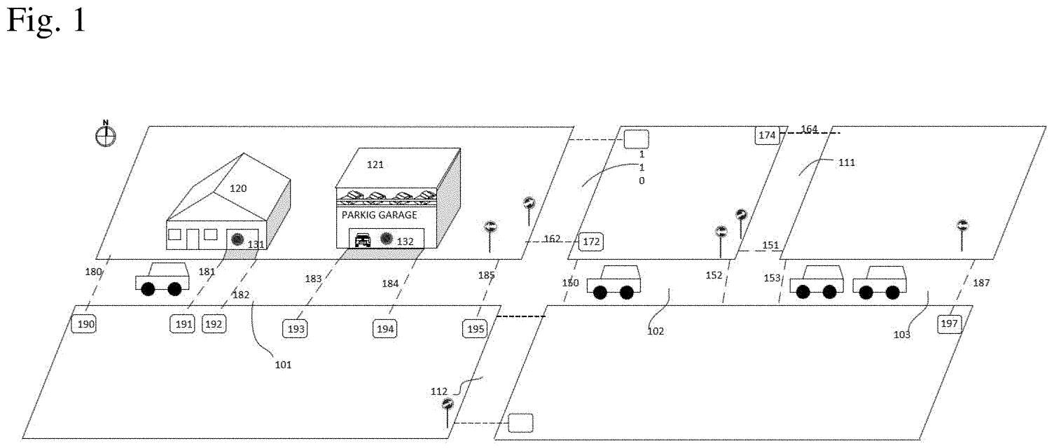

Now referring to exemplary FIG. 1, an illustration of the on-street parking system applied in six one-way city streets may be shown. In FIG. 1, streets 101, 102 and 103 may have traffic direction from east to west, and streets 110, 111 and 112 from south to north. The buildings 120 and 121 along street 101 may have pathways leading to off-street parking 131 and 132, respectively. As a result, street 101 may be covered by three street segments defined by the segment limits 180 & 181, 182 & 183, and 184 & 185, respectively. The segment limits 180-185 may have their dedicated smart nodes 190-195. In one embodiment, streets 102, 103 and 111 may have three street segments defined by the segment limits 150 & 152, 153 & 187, 151 & 164, respectively. Here, since there is no other uncontrolled pathway or route leading to or originating from the street segments, all vehicles entering the street 103, 102, and 111 from the street segment limits 187, 152, and 151 respectively, unless violating the traffic direction of the street, will have to go out from the street limits 153, 150, or 164 respectively before passing from any other segment limit. Alternatively, streets 102, 103, and 111 may be combined into one big street segment defined by an entrance segment limit 187, an exit segment limit 164, and a second exit segment limit 150. The segment limits 187 and 164 may have smart nodes 197 and 174, respectively. Since a vehicle passing from the segment limit 150 can either go north crossing the segment limit 162 (and thus be identified by the smart node 172) or go west crossing the segment limit 185 (and thus be identified by the smart node 195), the segment limit 150 may have no smart node. In essence, smart nodes 195 and 172 become the “end nodes” of segment limit 150 since both of them together, can capture and identify all the vehicle traffic crossing segment limit 150.

The smart node may be arranged at such a physical location as on the street, on the sidewalk, on the side of the street or in an elevated position, depending on the type of sensor used. For example, a video sensor and a Radio Frequency Identification (RFID) sensor may need to be placed in an elevated position. The elevated position may be on traffic lights, lighting poles, signs, standalone poles and columns, or even on building walls. Furthermore, a smart sensor monitoring a segment limit might not need to be physically aligned with the limit but may be disposed close by.

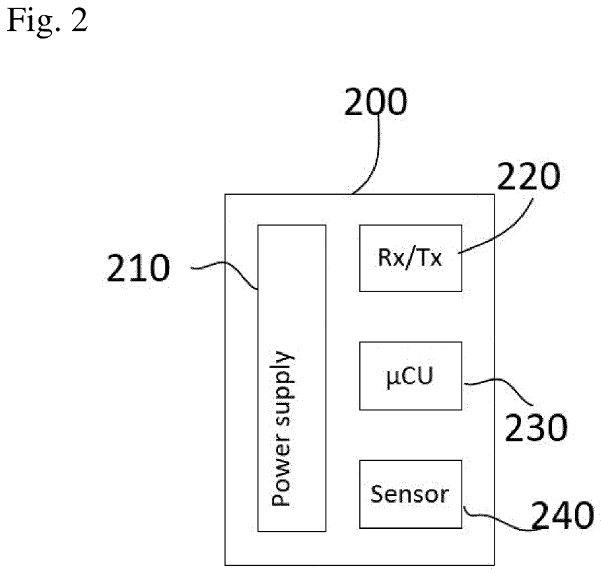

Now referring to exemplary FIG. 2, an exemplary embodiment of the components of a smart node 200 may be shown. The smart node 200 may have four main functional blocks: a power supply 210, a transceiver (Rx/Tx) 220, a microcontroller 230, with or without an embedded memory, and a sensor 240. The power supply 210 may provide the necessary voltage and current to the other components. The transceiver (Rx/Tx) 220 may enable wireless and/or wired communication. The sensor 240 may perform vehicle identification and counting tasks. The microcontroller 230 may be responsible for synchronizing all the other components, analyzing the data from the sensor 240 and/or the transceiver (Rx/Tx) 220, and organizing the information to be sent via the transceiver (Rx/Tx) 220.

Identification of vehicles may be carried out in a variety of manners such as but not only limited to RFID, Vehicle to Infrastructure (V2I, or V2X) connectivity, vehicle telematics data, and vehicle license plate recognition (with the use of cameras). In one embodiment, a smart node may use one or more of the three different ways to identify a vehicle, as desired. Furthermore, the identification process may be performed at a remote server while using the data one smart node may provide.

A smart node may communicate wirelessly and/or wired with other smart nodes, with vehicles, or with other infrastructures including, but not only limited to parking meters, traffic lights, streetlights, and remote servers. The smart node may receive information including, but not only limited to configuration commands, commands for performing various calculations, data analyzing commands, and commands for transmitting and relaying information. The smart node may transmit information including, but not only limited to vehicle counts, rate of vehicle count, timing of the event, vehicle identification data such as the driving plate, color of a vehicle, shape, dimensions, the brand of a vehicle and its model type. Furthermore, it may transmit stored and/or live video and images, sounds and any other environmental measurements, already processed by the smart node or not.

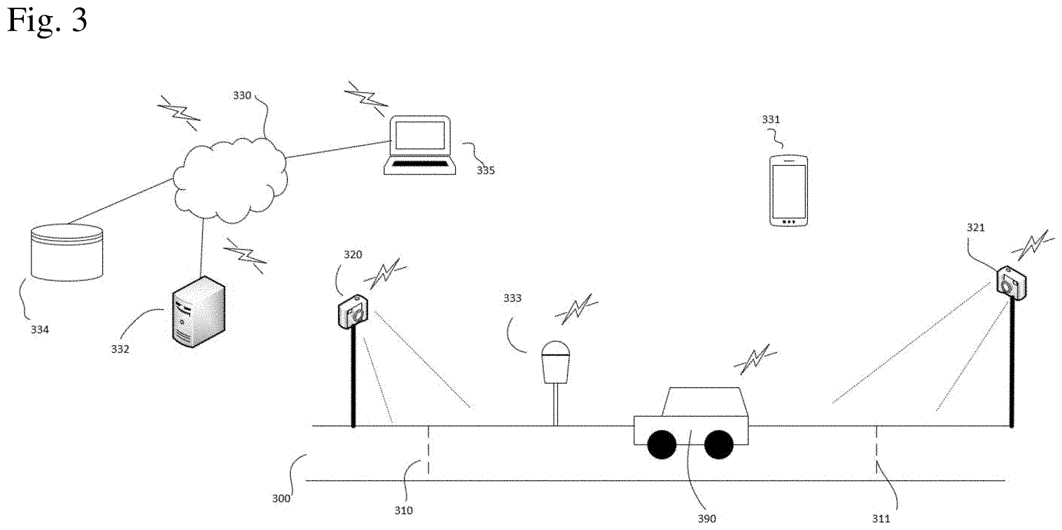

Now referring to exemplary FIG. 3, an illustration of the on-street parking system applied in a street segment may be shown. The street segment on street 300 may be defined by segment limits 310 and 311 and the direction of the street is from right (segment limit 311) to left (segment limit 310). Smart nodes 320 and 321 may be responsible for monitoring the segment limits 310 and 311 respectively and measuring the time a vehicle 390 spent in the street segment. This time measurement may be performed from a smart node or from a remote server 332 by comparing the timestamps taken for smart nodes 320 and 321 corresponding to the identification of vehicle 390 crossing the segment limits 310 and 311 respectively. The smart nodes 320 and 321 may communicate with each other. They may also communicate with a parking meter 333, a remote server 332, and the vehicle 390. The communication can be done directly or through a remote server.

In an embodiment, the measured time may be used for calculating the appropriate parking fees and for charging the vehicle 390 automatically the corresponding parking costs for being parked within the street segment defined by the segment limits 310 and 311. This process may be associated with an automatic payment system but may also take into account any other payments done via a parking meter 333, a mobile or handheld device 331 and or vehicles with connectivity and payment capabilities 390.

In another embodiment, in order to complete a parking payment, a user might register the license plate of the vehicle 390 at/with the parking meter 333 and specify a monetary amount and or a parking duration. The parking payment might also be completed with a handheld or a mobile device 331 or via a vehicle 390 that has an advanced microcontroller and connectivity capabilities. If the vehicle 390 is not registered in the automatic on-street payment system as disclosed, the measured time the vehicle has spent in the street segment may be compared against the specified parking duration. At the same time the corresponding parking fees may also be compared against any payments the user might have done via at least one electronic transaction.

In another embodiment, the vehicle 390 may be equipped with one of the following or a combination of the following (but not only limited to): wireless/data connectivity, Vehicle to Infrastructure (V2X) communication capabilities and with RFID capability.

In another embodiment if the paid parking time for the vehicle has expired or if a user never paid any parking fees or if the calculated charges are more than what was paid for the specific parking event the system may automatically calculate a fee and or a fine and do at least one or more of the followings but not only limited to: sending to the vehicle's owner the bill or a citation, charging the account corresponding to the specific vehicle, and notifying appropriate authorities.

The remote server 332 may be connected to a database 334 in which car identification information and corresponding account information is stored. Users/drivers may setup account information and/or pay for parking using a remote computer 335 and/or a mobile electronic device, such as a smartphone or a mobile device 331, via vehicle with communications capabilities, like 390 or, over a computer network 330, such as the Internet.

In another embodiment, the measured time the vehicle 390 has spent in the street segment defined by the segment limits 310 and 311 may be used for charging the vehicle automatically a fee for using/passing through this street segment. This may also include but is not only exclusive to parking charges. If the vehicle is registered in an automatic payment system then the payment of the above fee may be performed automatically/seamlessly. If not the fine and or a notice may be sent to the vehicle's owner and or the appropriate authorities.

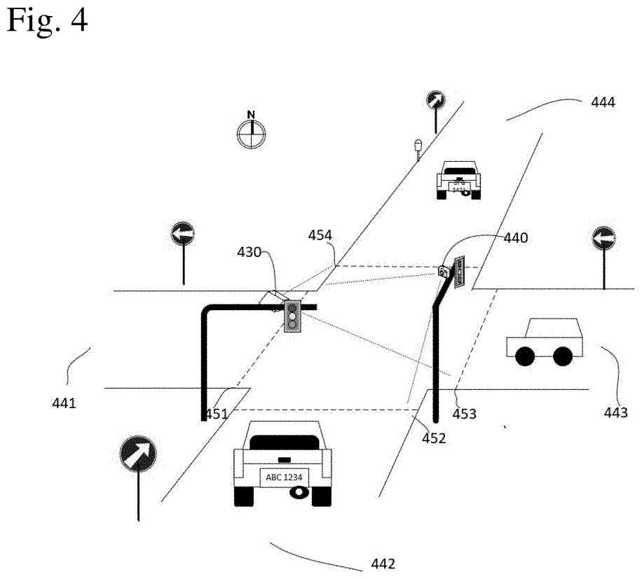

Referring now to FIG. 4, an exemplary arrangement of the smart nodes for a crossroad with four streets may be shown. The four street segments 441, 442, 443, and 444 may have segment limits 451, 452, 453 and 454, respectively. These four segment limits may be monitored by four dedicated smart nodes but in this case by two smart nodes 430 and 440 that have the capability to monitor all four street segment limits. The smart nodes 430 and 440 may identify vehicles by means of such as, video monitoring, automatic license plates recognition, RFID or V2X communication.

In an embodiment, the smart node 430 may be responsible for monitoring segment limits 453 and 454, while the smart node 440 for monitoring segment limits 451 and 452.

In another embodiment, one smart node placed carefully may be responsible for monitoring all four segment limits 451, 452, 453, and 454 (although in this case, monitoring only two of them (e.g. 451 and 454) may be enough). Such a smart node may use multiple video sensors, or a video sensor with wide lenses, and/or RFID and V2X capabilities.

It is noted that while the drawings show that there may be an unassigned portion of street between two proximate street segments, exemplary embodiments of the present invention need not be limited to such an arrangement and two proximate street segments may abut such that there is no unassigned portion of street therebetween. However, it is noted that where unassigned portions of street are present between proximate street segments, these unassigned portions of street may be portions of street in which parking is either illegal or improbable, such as in an intersection.

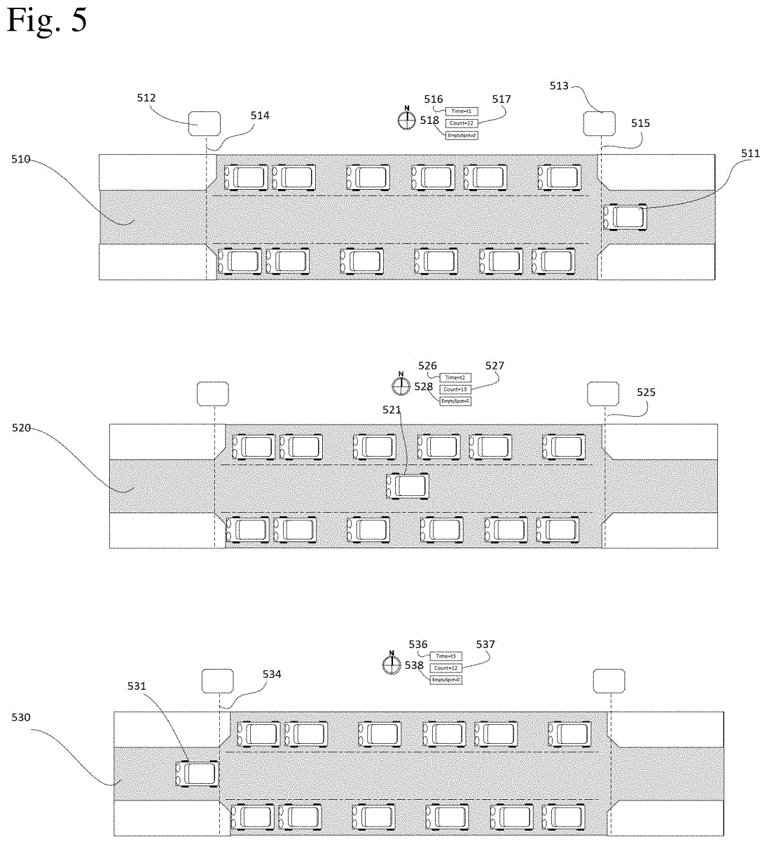

Now referring to exemplary FIG. 5, an illustration of a same one-way street at different time points t1, t2, and t3 may be shown. As depicted, the street has a traffic direction from east to west.

The top part shows that a street 510 may have a street segment defined by segment limits 514 and 515. Smart nodes 512 and 513 may be arranged in connection with the segment limits 514 and 515, respectively. At the time point t1, twelve vehicles are parked in the street segment, and there is no empty parking space left. A vehicle 511 is approaching the street segment and is about to cross the entrance segment limit 515. Three system variables may be used: Time 516, which may be a global variable shared among all smart nodes in the system and hold the current time, Count 517, which may hold the count of vehicles currently located in the street segment, and EmptySpot 518, which may hold the estimated available parking spots within the street segment. In this case, Time 516 may have the value of “t1”, Count 517 “12”, and EmptySpot 518 “0”. These variables may be stored in registers within the smart nodes, on a remote server (not shown in FIG. 5), on a nearby parking meter (not shown in FIG. 5) or elsewhere.

In the middle part, the same street at a later time point t2 may be shown (520). At this time point, the vehicle 511 is referenced to as 521, and has already crossed the segment limit 525. The vehicles parked in the street segment remain unchanged. The fact that the vehicle 521 is inside the street segment increases the total number of vehicles in the street segment by one. In this case, Time 526 may have the value of “t2”, Count 527 “13”, and EmptySpot 528 “0”.

In the bottom part, the same street at a further later time point t3 may be shown (530). At this time point, the vehicle 511 is referenced to as 531, and has already crossed the segment limit 534. The vehicles parked in the street segment remain unchanged. The fact that the vehicle 531 is outside the street segment decreases the total number of vehicles in the street segment by one. In this case, Time 536 may have the value of “t3”, Count 537 “12”, and EmptySpot 538 “0”. In another embodiment data coming from the vehicles via wireless/data or V2X communication during any point of the time events described in 510, 520, and 530, may be used for updating the system's data and its registers. This data may include but is not only limited to identification, vehicle status and geolocation data. In another embodiment a smart node featuring computer vision or remote sensing capabilities may detect the motion and or the trajectory of a vehicle 531 within the street segment (including “parking” or “departure from parking position” events) and update the system's data and its registers before the exit of the vehicle from the street segment.

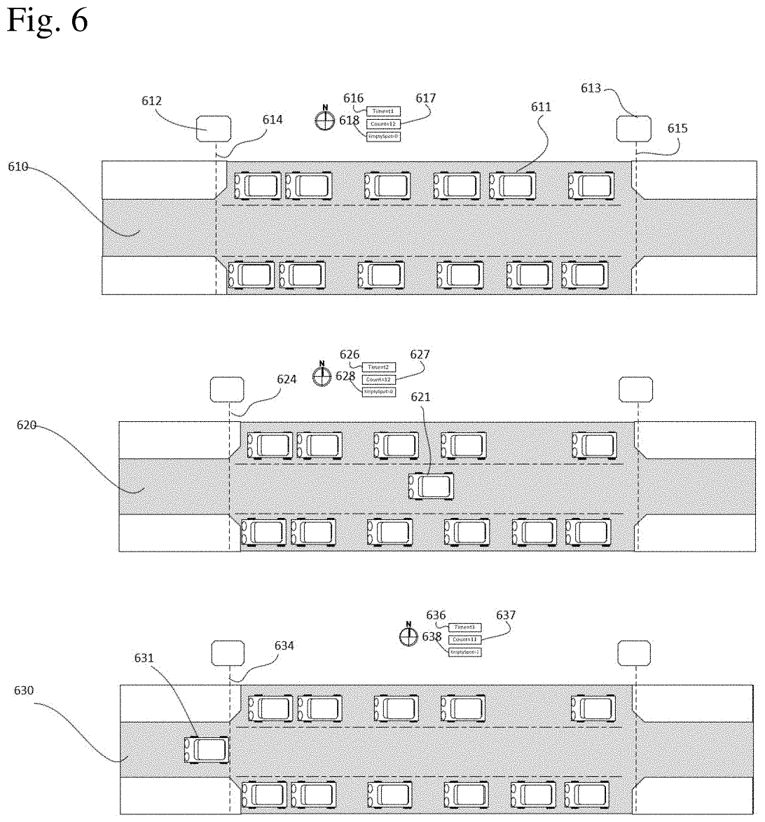

Now referring to exemplary FIG. 6, another illustration of a same one-way street at different time points t1, t2, and t3 may be shown. The top part shows that a street 610 may have a street segment defined by segment limits 614 and 615. Smart nodes 612 and 613 may be arranged in connection with the segment limits 614 and 615, respectively. At the time point t1, twelve vehicles are parked in the street segment, and there is no empty parking space left. A vehicle 611 is one of the vehicles parked in the street segment. Three system variables may be used: Time 616, which may be a global variable shared among all smart nodes in the system and hold the current time, Count 617, which may hold the count of vehicles currently located in the street segment, and EmptySpot 618, which may hold the estimated available parking spots within the street segment. In this case, Time 616 may have the value of“t1”, Count 617 “12”, and EmptySpot 618 “0”. These variables may be stored in registers within the smart nodes, on a remote server (not shown in FIG. 6), on a nearby parking meter (not shown in FIG. 6) or elsewhere.

In the middle part, the same street at a later time point t2 may be shown (620). At this time point, the vehicle 611 is referenced to as 621, and is still within the street segment but has left its previously occupied parking spot. The rest of the vehicles parked in the street segment remain unchanged. Although there is one released parking spot, the system has not yet identified it because the vehicle 621 has not exited the street segment. In this case, Time 626 may have the value of “t2”, Count 627 “12”, and EmptySpot 628 “0”.

In the bottom part the same street at a further later time point t3 may be shown (630). At this time point, the vehicle 611 is referenced to as 631, and has already crossed the segment limit 634. The rest of the vehicles parked in the street segment remain unchanged. The fact that the vehicle 631 is outside the street segment decreases the total number of vehicles in the street segment by one. In this case, Time 636 may have the value of “t3”, Count 637 “11”, and EmptySpot 638 “1”. In another embodiment data coming from the vehicle 631 via wireless/data or V2X communication during any point of the time events described in 610, 620, and 630, may be used for updating the system's data and its registers. This data may include but is not only limited to identification, vehicle status and geolocation data. In another embodiment a smart node featuring computer vision or remote sensing capabilities may detect the motion and or the trajectory of a vehicle 631 within the street segment (including “parking” or “departure from parking position” events) and update the system's data and its registers before the exit of the vehicle from the street segment.

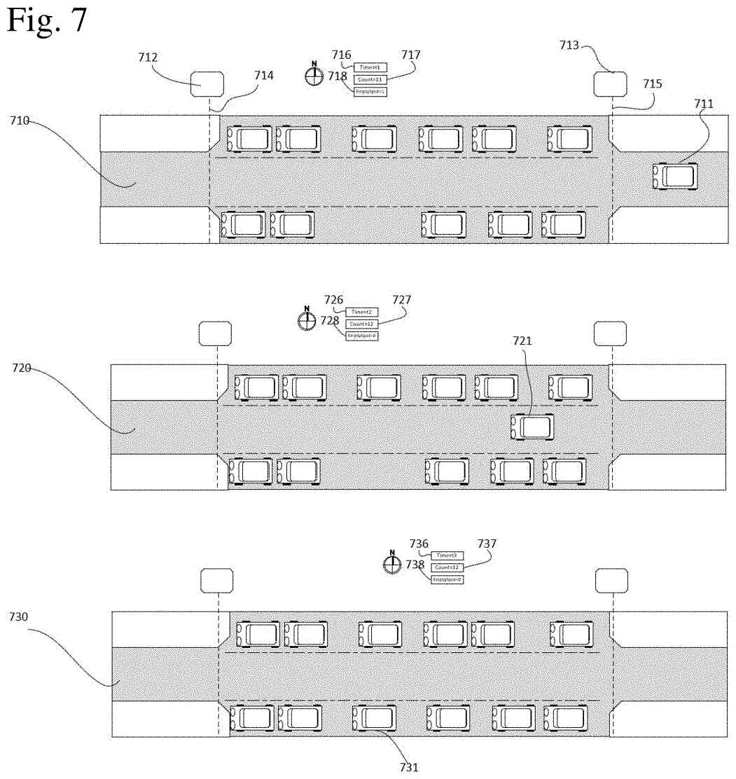

Now referring to exemplary FIG. 7, another illustration of a same one-way street at different time points t1, t2, and t3 may be shown. The top part shows that a street 710 may have a street segment defined by segment limits 714 and 715. Smart nodes 712 and 713 may be arranged in connection with the segment limits 714 and 715, respectively. At the time point t1, eleven vehicles are parked in the street segment, and there is one empty parking space left. A vehicle 711 is outside the street segment and is approaching the segment limit 715. Three system variables may be used: Time 716, which may be a global variable shared among all smart nodes in the system and hold the current time, Count 717, which may hold the count of vehicles currently located in the street segment, and EmptySpot 718, which may hold the estimated available parking spots within the street segment. In this case, Time 716 may have the value of “t1”, Count 717 “11”, and EmptySpot 718 “1”. These variables may be stored in registers within the smart nodes, on a remote server (not shown in FIG. 7), on a nearby parking meter (not shown in FIG. 7) or elsewhere.

In the middle part, the same street at a later time point t2 may be shown (720). At this time point, the vehicle 711 is referenced to as 721, and is now within the street segment but has not yet occupied the vacant parking spot. The rest of the vehicles parked in the street segment remain unchanged. Although there is one available parking spot, the system may assume a full parking spot occupancy by only looking at the number of the vehicles within the street segment. In this case, Time 726 may have the value of “t2”, Count 727 “12”, and EmptySpot 728 “0”. In another embodiment, those instantly changed variables may be reported to end users with a system defined delay period that may be tuned according to the traffic conditions and the street segment characteristics.

In the bottom part the same street at a further later time point t3 may be shown (730). At this time point, the vehicle 711 is referenced to as 731, and has already occupied the empty parking spot. The rest of the vehicles parked in the street segment remain unchanged. There is no other event triggered by a vehicle passing a segment limit. In this case, Time 736 may have the value of “t3”, Count 737 “12”, and EmptySpot 738 “0”. In another embodiment data coming from the vehicle 731 via wireless/data or V2X communication during any point of the time events described in 710, 720, and 730, may be used for updating the system's data and its registers. This data may include but is not only limited to identification, vehicle status and geolocation data. In another embodiment a smart node featuring computer vision or remote sensing capabilities may detect the motion and or the trajectory of a vehicle 731 within the street segment (including “parking” or “departure from parking position” events) and update the system's data and its registers before the exit of the vehicle from the street segment.

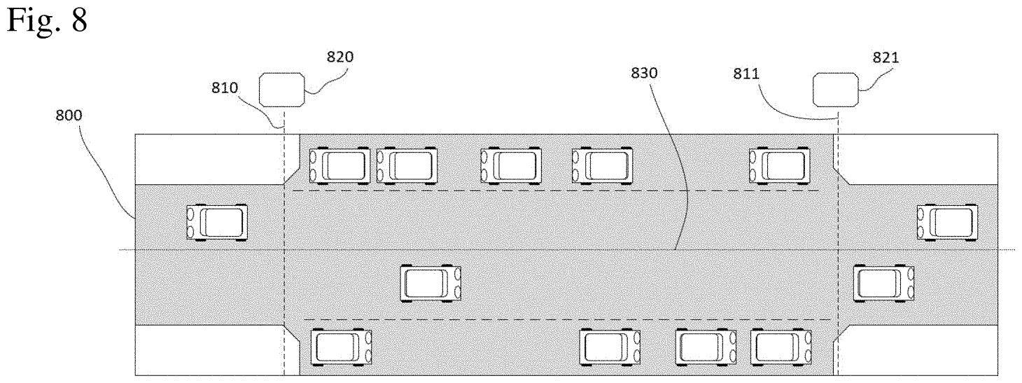

Now referring to exemplary FIG. 8, an illustration of the on-street parking system applied in a two-way street may be shown. The two-way street 800 may have two lanes separated by a demarcation line 830. In this street, there is a street segment defined by the segment limits 810 and 811. Two smart nodes 821 and 822 may be arranged in connection with the segment limits 810 and 811, respectively. The on-street parking system may work for this two-way street in a way similar to that for the one-way street. The demarcation line could be but not only limited to a dotted line, a dashed line, a straight line, or the combination of two parallel lines which are of the same or different types. Typically, when a car enters the street segment by crossing the segment limit 810 and detected from smart node 821, it is expected sooner or later to leave the street segment by crossing the segment limit 811 where it is supposed to be detected from smart node 822. In case the vehicle makes a U-turn through, it will be detected crossing the same segment limit a second time but with the opposite direction (in-to-out and not out-to-in).

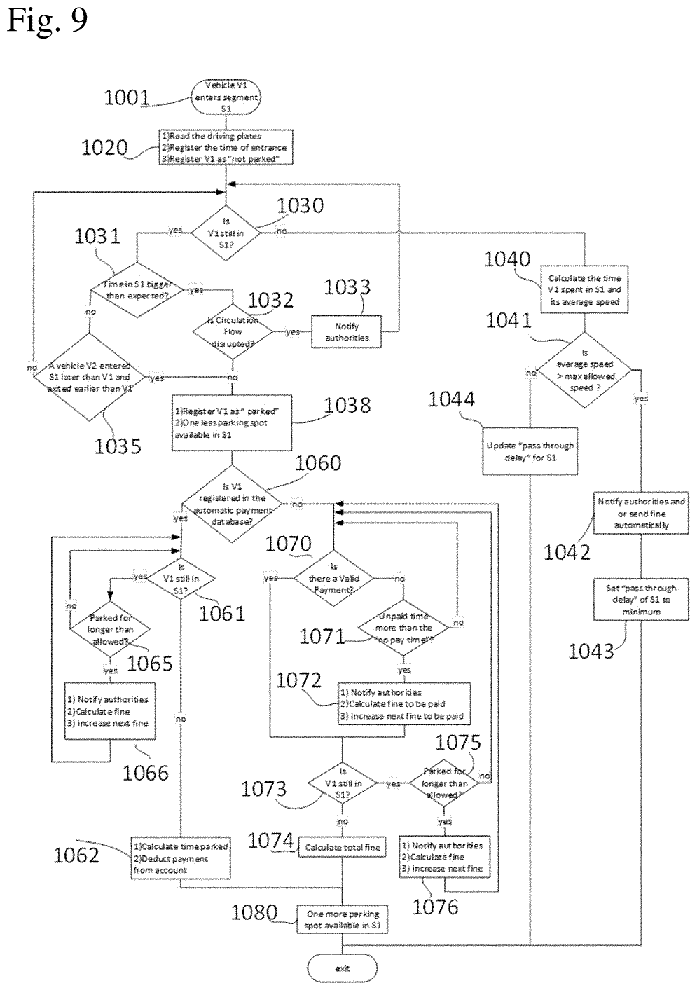

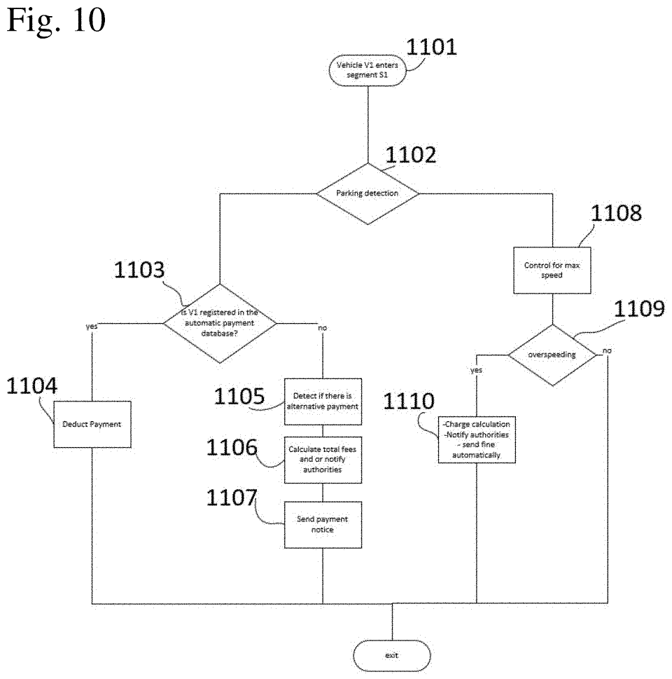

Now referring to FIG. 9, a flowchart for a method providing automatic on-street parking payment and unoccupied parking spot availability detection may be shown. In order not to confuse the key steps of the method, a simplified flowchart may be shown in FIG. 10. The process may be performed for every vehicle that enters a street segment S, and for every monitored street segment, regardless the traffic conditions. The process may start when a vehicle V enters the street segment S and its parameters and calculations are not correlated with possible data existing if this vehicle was in this street segment before.

The street segment S may have two smart nodes Nin and Nout arranged at the beginning and the end of the street segment, respectively. The smart nodes Nin and Nout may detect the vehicles that enter and exit the street segment S and record the timing of those events.

A parameter, “pass through delay” Tptd, may be defined as the time it takes for a vehicle to drive through the street segment S without stopping in order to park. The “pass through delay” Tptd may be specific to the street segment S and take different values over the day depending on traffic conditions. Tptd may have two parts: a fixed part, which may depend on the characteristic of the street segment S including but not only limited to its length, the street's maximum allowed speed, the presence of stop signs or traffic lights, and whether the vehicles coming out of the street segment S have priority; and a variable part, which may depend on traffic conditions and/or weather conditions. In one embodiment, the variable part of Tptd may take its value from other external systems including but not only limited to mapping and traffic monitoring applications such as WAZE and GOOGLE MAPS, each of which is developed by GOOGLE LLC and or its parent company ALPHABET INC., or another city traffic calculation systems. In another embodiment, Tptd may be determined internally. For example, the time that the last vehicle spent going through the street segment S may be used to set the new value of the “pass through delay” Tptd. In another embodiment, previous measurements from the vehicles that passed through the street segment S might be taken into account in an average or weighted average manner. In another embodiment, the “pass through delay” Tptd of adjacent street segments may be also taken into account. In another embodiment, historical data, including traffic of the day before, may be taken into account.

A parameter, “no pay time” Tnp, may be defined as the time period beyond which a vehicle within a street segment needs to have a valid payment. This parameter may be street segment specific and be set by the parking authorities. In one embodiment, the no pay time Tnp takes into account the actual traffic conditions and may change therefore dynamically, with the threshold time being dependent upon the vehicles' traffic flow and the time it takes to traverse the street segment. For example, the traffic conditions may include a characterization of the congestion and speed of traffic moving through the street segment and/or through other regions of the street close in proximity to the street segment. This characterization of traffic conditions may vary from “light” meaning traffic is sparse and/or fast moving, to “heavy” meaning traffic is congested and/or slow moving. The measure of speed may be an average speed of individual vehicles traveling through the roadway. The measure of congestion may be based on a total number of moving vehicles within a designated region of the roadway, such as the street segment.

The no pay time Tnp may be calculated using data provided by the sensors, such as cameras, of the smart nodes, with the maximum period of time within which no payment is assessed being extended as the time it takes for a vehicle to traverse the street segment increases. In another embodiment, Tnp may be set on the basis of the “pass through delay” Tptd. In another embodiment, Tnp may be set to zero. This may be the case when the system administrator wants to charge the vehicles for using (passing through) the street segment and not only for parking in it.

A variable, “circulation flow disruption” Circ_dist, may be defined, and triggered with the presence of some events in a street segment S that do not allow the vehicles to continue moving towards the exit of the street segment S that may include but is not only limited to a road closure or an accident.

In an embodiment, the whole process may start at Block 1001, when the smart node Nin1 of the street segment S1 detects that a vehicle V1 enters S1. Then, at Block 1020, Nin1 may identify the vehicle V1, register the entrance time, and mark V1 as “not parked”. In one embodiment, the smart node Nin1 may identify the vehicle V1 by means of license plate recognition. Alternatively, Nin1 may identify V1 through RFID or V2X communication or from other data originating from the car and communicated wirelessly.

Vehicle V1 may be marked as “parked” in the street segment S1 at Block 1038 if: (1) it is determined that vehicle V1 is still in street segment S1 at Block 1030, (2) it is determined at Block 1031 that the vehicle V1 stays within S1 for a time period longer than expected, given the traffic conditions, (e.g. the criteria may be but not only limited to the pass through delay Tptd of the street segment S1 for the specific time) and it is determined at Block 1032 that the circulation flow in S1 is not disrupted, or (3) although V1 has not stayed within S1 longer than expected, it is determined at Block 1035 that another vehicle V2 that entered S1 after V1 has exited S1 while V1 is still in S1.

If at Block 1032 it is determined that the circulation is disrupted, then the parking authorities may be notified at Block 1033.

At Block 1038, as the vehicle V1 is registered as parked, the system may be updated to show one less available parking spots in the street segment S1. The registration of the vehicle V1 as parked may also happen earlier if a parking notification is received originating from the vehicle V1 or the motorist/user by means of telematics and or wireless communication. A notification like that might include identification, geolocation and vehicle's status data. Alternatively, an early registration may happen if the smart nodes Nin1 and Nout1 have remote tracking and motion detection capabilities and detect the parking event of V1.

If the node Nout1, at Block 1030, detects that the vehicle V1 exits S1 and V1 was not marked earlier as parked in S1, then, at Block 1040, the system may calculate the time that the vehicle V1 spent within S1 and its average speed. The average speed may be calculated by taking into account the length of the street segment S1 and the timestamps corresponding to the identification of vehicle V1—performed by the smart nodes Nin1 and Nout1—when entering and leaving S1 respectively. If it is determined at Block 1041 that the average speed is more than the max allowed speed in S1, then the authorities may be notified at Block 1042, and then, the “pass through delay” Tptd for S1 is set at Block 1043 to a minimum defined value. If it is not determined at Block 1041 that the average speed is more than the speed limit of S1, the time that the vehicle V1 spent in S1 may be set at Block 1044 as the new “pass through delay” for the street segment S1.

In an embodiment this average speed calculation may be estimated between two points A and B that are not necessary part of the same street segment but may be segment limits of different street segments. In this case the average speed may be calculated by taking into account a) the timing information retrieved from the sensors/smart nodes monitoring point A and B and b) the minimum possible route/distance between points A and B such as to calculate the best-case scenario for the driver.

It is noted that the average speed referred to by Block 1041 may be determined by any known approach. For example, the average speed may be determined as taught by European Patent Specification EP 1870868, published on Oct. 8, 2008, which is herein incorporated by reference in its entirety.

At Block 1060, the process proceeds to a payment subprocess for the vehicle V1, which has been registered as “parked”, by searching in a remote database whether the vehicle V1 has been registered in the automatic payment system as disclosed in this disclosure. A motorist may enroll in the automatic payment system in advance to automate his parking payments. If the determination at Block 1060 is “yes”, then when the smart node Nout1 detects at Block 1061 that V1 exits S1, it records the exit time and the automatic payment system may calculate at Block 1062: a) the total time that the vehicle V1 spent in S1, and b) the parking charges for this calculated time that may include any fines. The calculation of the time may take into account parameters such as but not only limited to the no pay time Tnp parameter, the “pass through delay” Tptd at the time of entrance and exit of the street segment S1 and the time delay because of a circulation flow disruption. If the determination at Block 1061 is “yes”, it is determined at Block 1065 whether there is a maximum allowed parking time limit (e.g., as a parameter imposed by the cities) and it has been exceeded. When the maximum allowed parking time limit is exceeded, a separate fine may be issued, and the authorities may be notified in block 1066.

If it is determined at Block 1060 that the vehicle V1 is not registered in the automatic payment system, then the process may proceed to Block 1070 to determine whether there is a valid payment registered in the remote database through means of but not only limited to online, handheld and/or mobile device, any integrated payment system the vehicle may have, and payment through a parking meter. If it is determined at Block 1070 that there is no valid payment and it is determined at Block 1071 that the unpaid time is more than the “no pay time” Tnp, a designated time for which no payment is due, then at Block 1072, the authorities may be notified, a parking violation fine may be calculated, and the value for the next parking payment fine for V1 in S1 may be increased. The steps illustrated in Blocks 1070-1072 may be repeated till the smart node Nout1 detects at Block 1073 that V1 exits S1. Then, when it is determined at Block 1073 that the vehicle V1 is still in the street segment S1, it is assessed at Block 1075 whether there is a maximum allowed parking time limit and it has been exceeded. When the maximum allowed parking time limit is exceeded, a separate fine may be issued, and the authorities may be notified in block 1076. If it is determined at Block 1073 that the vehicle V1 has left the street segment S1, in Block 1074, a total fine may be calculated and issued, which may be a cumulation of smaller ones. This calculation might take into account the recorded time of V1 leaving S1 as determined/captured from the smart node Nout1. This calculation might also take into account parameters such as but not only limited to Tnp and Tptd. In one embodiment, any repeated payments during a prolonged stay may be taken into account. On the other hand, if it is determined at Block 1070 that there is a valid payment, a fine of zero value (or a void fine) may be calculated at Block 1074.

Because the vehicle V1, which was marked as “parked” in the street segment S1, is detected by the output smart node Nout1 as leaving S1, at Block 1080, a notification may be issued indicating the availability of an extra available parking spot in S1. This might happen earlier if by means of telematics and/or wireless communication originating from the vehicle V1 or the motorist, the system gets notified directly that the vehicle V1 is not parked any more. Alternatively, an early notification may happen if the smart nodes Nin1 and Nout1 have remote tracking and motion detection capabilities and detect the departure of V1.

The above described embodiments of automatic on-street parking payment system and method may apply to one-way streets. With slight modification, the system and method may also apply to streets with bidirectional traffic. Two street segments parallel to each other may be defined in a two-way street. Smart nodes may be provided in the segment limits, and responsible for bidirectionally detecting the vehicles that enter and exit the street segments.

According to the simplified flowchart of FIG. 10, first the vehicle V1 is registered as entering the segment S1 (Block 1101). Thereafter it is determined whether the vehicle V1 is traveling through the segment or parking therein (Block 1102). If the vehicle V1 is determined to be parked then it is determined whether the vehicle V1 is registered in the automatic payment database (Block 1103). If it is registered, then payment may be deducted (Block 1104). If it is not registered, then it is determined whether alternative payment is available (Block 1105). Then total fees may be calculated and authorities may be notified if needed (Block 1106). Thereafter notice of payment may be sent (Block 1107). If, however, it is determined that the vehicle V1 is not parked (Block 1102), then maximum speed of the vehicle through the segment may be monitored (Block 1108) and then it is determined if the vehicle has exceeded the speed limit (Block 1109). If it is so determined then the authorities may be notified and/or a fine assessed (Block 1110).

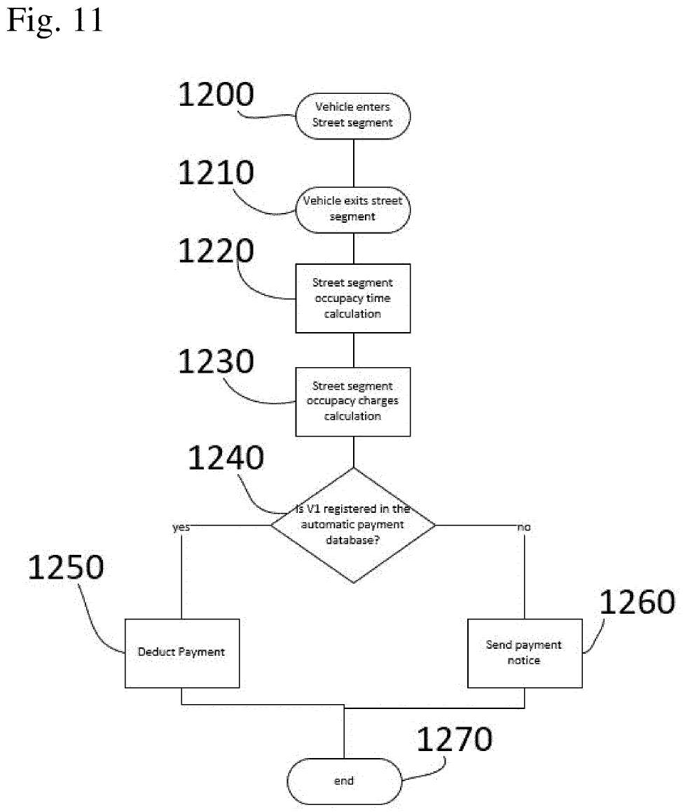

Now refer to FIG. 11, a flowchart for the subprocess of street segment occupancy detection and calculation may be shown. The vehicles may be charged based on occupancy in a specific street segment. Such system may also include the parking charges and may be used together or independently from the system of FIG. 9. Charges may be varied according to the following parameters but not only limited to: the duration of the street segment occupation, day and time, traffic conditions, city rules and circulation restrictions, vehicle size, age and type.

The same principle may be applied to a joint combination of a plurality of nearby street segments forming a street segment area where the vehicles coming in and out from the area are monitored.

This process may be performed simultaneously for every vehicle that enters a street segment of any length and for every monitored street segment, regardless the traffic conditions.

The process starts at Block 1200 with the detection of a vehicle entering a segment. When, at Block 1210, the same vehicle exits the segment, the system, that has logged the vehicle's entrance and exit time at Blocks 1200 and 1210 respectively, may calculate the total time the vehicle has spent in the street segment at Block 1220 and the total applicable charges for using/occupying the segment at Block 1230. Then the system determines if the vehicle is registered in the automatic payment database/system at Block 1240. If the vehicle is indeed registered, then the charges are deducted automatically from an account/digital wallet registered for the specific vehicle at Block 1250. If not, a payment notice may be sent to the owner of the vehicle or to the officials in charge of the system usage or to another appropriate organization at Block 1260. The process may end at Block 1270.

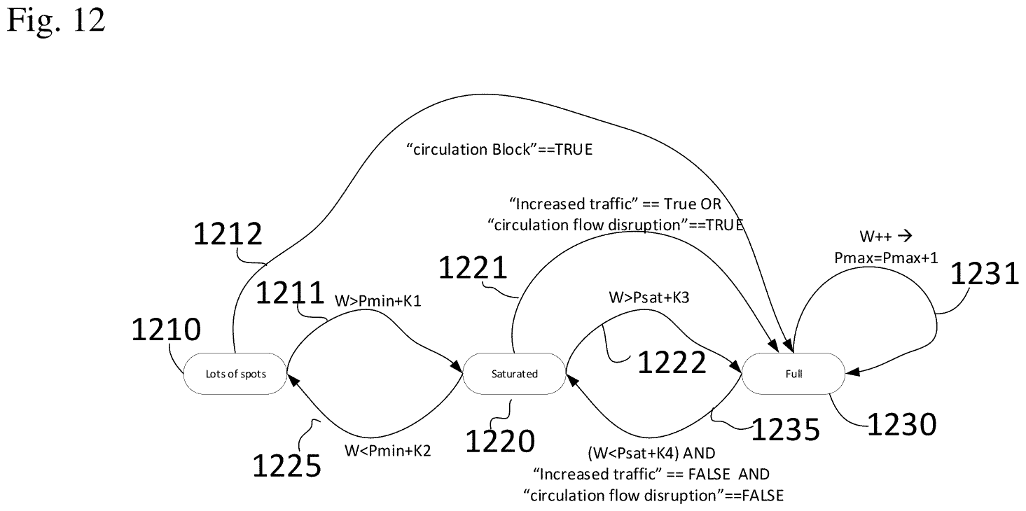

Now refer to FIG. 12, a state diagram for available parking spot indication may be shown. In an embodiment, there may be three states of parking occupancy or availability of a street segment: Lots of spots, Saturated, and Full. In other embodiments, there could be more or fewer states. In FIG. 12, “W” may refer to the number of vehicles in the street segment; it may be changed by the flowchart shown in FIG. 9 and/or the steps shown in FIGS. 5, 6, 7 and 8. The parameter “increased traffic” may be defined as a parameter of the street segment and correlated to the increased “pass through delay”.

A parameter Pmin may be a threshold specific to a street segment, referring to the number of occupied parking spots in the street segment below which there are plenty of available parking spots.

A parameter Psat may be another threshold specific to a street segment, referring to the number of occupied parking spots in the street segment beyond which it is difficult to find an available parking spot. Psat is greater than Pmin (Psat>Pmin). The parameter Psat may be influenced by various parameters, including but not only limited to the theoretical number of slotted parking spots the street segment may fit, and the type of parking allowed in the street segment (e.g., parallel parking, or parking in angle). Psat may change dynamically based on the summation of the length of the identified vehicle parked in the street segment. For example, the length of a vehicle may be calculated based on the vehicle identification (e.g., brand, model or the like) or by simply video processing performed from the smart nodes.

A parameter Pmax may be another threshold specific to a street segment, referring to the maximum number of occupied parking spots a street segment may have. Pmax is greater than Psat (Pmax>Psat). The parameter Pmax may be dynamic in the street segment, depending on various factors, including but not only limited to the length of the street segment, whether there are parking spots under angle or parallel to the street segment, and the length of the vehicles identified within the street segment.

Kx may refer to a plurality of system-defined parameters that are specific to a street segment. The number of Kx depends on the number of states. In a state diagram for a street segment with three states, a group of four parameters K1, K2, K3 and K4 may be enough. The purposes of Kx is to provide hysteresis (if needed) to the state transitions and they may be positive or negative numbers. Furthermore Kx may also be dynamic parameters: they might depend, for example, on the time of the day or on the traffic conditions

In FIG. 12, the state “Lots of Spots” shown in Block 1210 may be a state in which the street segment may have a plurality of available parking spots. From the state “Lots of Spots”, if the number of parked vehicles W increases above the value of “Pmin+K1”, there may be a state transition as illustrated by the arrowed line 1211 to the state “Saturated” shown in Block 1220. Also, from the state “Lots of Spots”, if there is a determination of “circulation block” (or “circulation flow disruption” as determined at Block 1032 in FIG. 8), there may be a state transition as illustrated by the arrowed line 1212 to the state “Full” shown in Block 1230.

From the state “Saturated” shown in Block 1220, if W becomes smaller than the value of “Pmin+K2”, then there may be an opposite state transition as illustrated by the arrowed line 1225 back to the state “Lots of Spots” shown in Block 1210. Or, if there is a determination of “increased traffic” in the street segment S1 and/or in the nearby street segments (1221), or if there is a determination of“circulation flow disruption” (as determined at Block 1032 in FIG. 8), or if W increases above the value of “Psat+K3”, there may be a state transition as illustrated by the arrowed lines 1221 and 1222 to the state “Full” shown in Block 1230.

From the state “Full” shown in Block 1230, if W decreases below the value of “Psat+K4” and there is neither a determination of“circulation flow disruption” nor of “increases traffic” in S1 and/or in the nearby street segments, an opposite state transition as illustrated by the arrowed line 1235 to the state “Saturated” shown in Block 1220 may happen.

From the state “Full” shown in Block 1230, the increase of W may lead to the increase of Pmax as illustrated by the arrowed line 1231. Under this circumstance, there may be no state transition, though a change in other state diagram parameters may be caused. The information on the status of a street segment such as but not only limited to the: the parking occupancy state (e.g., Full, Saturated, Lots of Spaces, Someone Just Left, etc.), the actual number of cars in a street segment, the estimated traffic conditions and any circulation flow disruption may be reported to the parking authorities, the motorists and the public through a dedicated website and/or applications for handheld or other portable devices or vehicles.

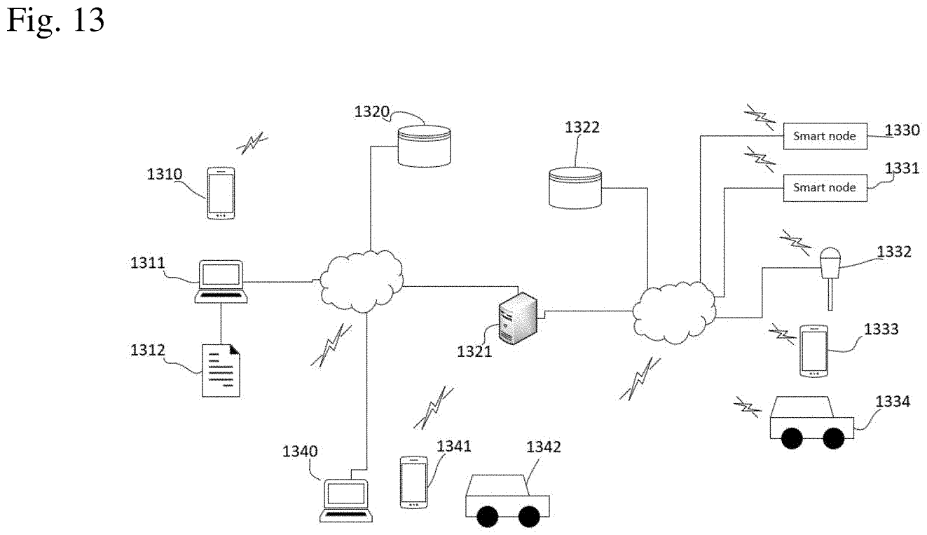

Now refer to FIG. 13, the data interaction between the different components of the system may be shown. The first level of interaction may begin with the users signing up for the automatic payment system. This may be done via a web form and a dedicated application by using an electronic device such as but not only limited to a handheld device 1310 or a computer. Alternatively, it may be done with a written form 1312 but in this case an authorized person may need to process the data electronically using a computer system 1311. The registration may include, among other data, parameters such as but not only limited to the following: the vehicle's registration data, its license plate, the brand, the model the color and a preferred payment method. The preferred payment method may be but not only limited to credit card information, a bank account where charges may be deducted, a digital online wallet or a demand to receive the bill electronically or to be sent to the user. All this information may be stored securely in a remote database 1320.

The second level of data interaction may be between the hardware of the system and the users while parking or trying to pay. This may be coordinated from a remote server 1321. The remote server may communicate with a plurality of electronic devices including but not only limited to a plurality of smart nodes like 1330 and 1331, with electronic parking meters 1332, mobile and/or handheld devices 1333 or Vehicles 1334. This information may be transmitted in the form of blockchained cryptographic or any other encrypted data and may be stored to a database such as 1320. Furthermore, the server 1321 may also communicate with other remote databases such as 1322 and remote servers in order to access information regarding an identified vehicle. This information may include but not only limited to vehicles' registration data, insurance data and law enforcement databases.

The smart nodes 1330-1331, via wired or wireless communication, may communicate with the server 1321, the parking meter 1332, a vehicle 1334 or any user with a mobile and/or handheld device 1333 or relay to each other information such as but not only limited to the identification of vehicles, timing events, or other messages/data they received from other system components/users. If this information concerns vehicles registered in the automatic payment system, then a payment may be deducted automatically. The smart nodes may also send information such as but not only limited to live or stored: captured images, video and audio signals. Furthermore, the smart nodes may interact with other city infrastructure such as traffic lights or city lights or display boards.

A vehicle like 1334 may wirelessly communicate with a smart node like 1330-1331 or a parking meter 1332 or a server 1321, transmitting information such as but not only limited to: vehicle identification information and payment commands or vehicle state data, geolocation data and payment transaction data and commands. This may be done by means such as but not only limited to RFID, V2X communication by using, any wireless connectivity data protocol such as Global System for Mobile Communications data (such as GSM or cellular data, G3, G4, G5) or Short Message Service (SMS, text messages). This information might include commands from digital wallets.

A user, after parking his vehicle, may use the parking meter 1332 to pay the parking charges by declaring his vehicle's license plate, the desired duration and using a mean of payment such as but not only limited to cash or any electronic transaction. This information may be transmitted from the parking meter 1332 with wired or wireless communication to the smart nodes 1330-1331 and/or to the server 1321.

Alternatively, a motorist may use, within his vehicle 1334 or out of it, one of the following but not only limited to: a handheld and/or mobile device 1333 or any other electronic device, or a personal digital assistant, or any embedded application or software in the vehicle utilizing the vehicle's communication capabilities to send payment commands through a website or an application. This may be done by identifying the vehicle and specifying the desired parking duration and or the desired amount of money to be paid. The payment itself may be done by means such as but not only limited to a digital wallet, a credit card and by a bank transfer. This information may be sent directly to the server 1321 or to any other intermediate repeaters.

A third level of data interaction may have to do with the communication of the system with the parking authorities, and the motorists. These may be administration commands and may also include information on the status of each street segment such as but not only limited to: the parking occupancy state (e.g., Full, Saturated, Lots of Spaces, Someone Just Left, etc.), the actual number of cars in a street segment, the estimated traffic conditions and any circulation flow disruption. This information may be shared through a dedicated website, software packages or applications for handheld and/or mobile device or for vehicles or a digital assistant which may have different flavors and capabilities when being used from system administrators, parking authorities, city officials, subscribed motorists or the public. This information may be accessed wirelessly or with wired communication by means of electronic devices such as computers 1340 or any kind of mobile and handheld device 1341, digital assistants, or may be even accessed from motorists via the vehicles' infotainment system 1342.

The idea disclosed here finds application in on-street parking management and enforcement in urban areas. However, it is appreciated that the present exemplary embodiments are also amendable to other applications. For an example, the system and method as disclosed also may apply to indoor parking management and enforcement. For another example, the time that a vehicle spent within an area (e.g., a city center) may be tracked for the purpose of assessing a fee associated with road usage. Also, the time that a vehicle spent in a street segment may be tracked for one or a combination of the following purposes: calculating parking charges, assessing fines associated with breaking rules of the roads (e.g., violating max speed limitation, city circulation restrictions, or the like), detecting parking spot availability, calculating or estimating traffic, and directing motorists to vacant parking spots. Parking time duration of a vehicle may be counted as starting at the moment the vehicle enters the street segment and ending when the vehicle leaves the street segment. Furthermore, a given period of free parking time may be subtracted from the total measured parking time. The estimation of parking availability may be communicated to the parking authorities, the motorists and/or the public in the form of occupied states (e.g., Full, Saturated, Lots of Spaces, Someone Just Left, etc.) of the parking spaces. This estimation may also be indicated in the form of exact number of vacant parking spots, traffic conditions and/or any circulation flow disruption. This may be done via a website and/or dedicated applications for handheld and mobile devices or for vehicles, through a digital assistant.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for automated on-street parking control, comprising:
determining traffic conditions in a street segment using a first sensor disposed at a first end of the street segment and/or a second sensor disposed at a second end of the street segment, the second end being an opposite end to the first end;
determining a time that a vehicle enters the street segment using the first sensor and/or the second sensor;
identifying the vehicle using the first sensor and/or the second sensor;
determining a time that the vehicle exits the street segment using the first sensor and/or the second sensor and calculating an elapsed time as a difference between the determined time that the vehicle exits the street segment and the determined time that the vehicle enters the street segment;
determining a threshold time that is dependent upon the determined traffic conditions such that as the determined traffic conditions are heavier, the threshold time is longer; and
determining whether the elapsed time exceeds the threshold time and assessing a fee only when the elapsed time exceeds the threshold time, a value of the assessed fee being calculated from the elapsed time.

2. The method of claim 1, wherein the first sensor and/or the second sensor is a camera module, a radar speed detector, a laser speed detector, and/or a radio frequency identification (RFID) detector.

3. The method of claim 1, further comprising:
receiving a payment from a driver of the vehicle;
comparing a value of the payment received from the driver of the vehicle to the value of the assessed fee; and
assessing a fine to the driver of the vehicle only when the assessed fee is greater than the payment received from the driver of the vehicle.

4. The method of claim 1, wherein identifying the vehicle includes using the first sensor and/or the second sensor to read a license plate number of the vehicle or to read a radio frequency (RF) identification tag installed within the vehicle or using other geolocation and/or identification data transmitted from the vehicle via telematics or vehicle to infrastructure (V2X) communication.

5. The method of claim 1, wherein the street segment is a thoroughfare with one or more parking spaces on a shoulder thereof.

6. The method of claim 1, wherein the determined traffic conditions are measured by calculating a rate of one or more additional vehicles crossing a limit of the street segment.

7. The method of claim 1, further comprising determining a speed of the vehicle, either:
based on the elapsed time and a known length of the street segment or using a radar/laser speed detector disposed within the first sensor and/or the second sensor and sending a registered owner/driver of the vehicle a citation when the determined speed exceeds a legal speed limit, or
based on a time taken for the vehicle to pass between two points separated by a known route distance, the two points not necessarily being the first or second end of the street segment.

8. The method of claim 1, further comprising sending a registered owner/driver of the vehicle a citation when the elapsed time exceeds a maximum legal parking time.

9. The method of claim 1, wherein when a difference between a current time and the time the vehicle enters the street segment exceeds the threshold time, a counter of parked vehicles within the street segment is advanced by one unit and then when it is determined that the vehicle exits the street segment, the counter of parked vehicles within the street segment is reduced by one unit.

10. The method of claim 9, wherein the counter of parked vehicles and/or an availability of parking spaces which is determined therefrom is shared with one or more devices of other vehicles.

11. The method of claim 1, wherein the street segment is a first street segment, a second street segment continues from the first street segment, and the determined time that the vehicle exits the first segment is used as a time that the vehicle enters the second segment.

12. A method for automated street tolling, comprising:
determining a time that a vehicle enters a street segment using a first sensor disposed at a first end of the street segment and/or a second sensor disposed at a second end of the street segment;
identifying the vehicle using the first sensor and/or the second sensor,
determining a time that the vehicle exits the street segment using the first sensor and/or the second sensor and calculating an elapsed time as a difference between the determined time that the vehicle exits the street segment and the determined time that the vehicle enters the street segment; and
assessing a fee for time spent within the street segment according to the elapsed time.

13. The method of claim 12, wherein the first sensor and/or the second sensor is a camera module, a radar speed detector, a laser speed detector, and/or a radio frequency identification (RFID) detector.

14. The method of claim 12, wherein identifying the vehicle includes using the first sensor and/or the second sensor to read a license plate number of the vehicle, to read a radio frequency (RF) identification tag installed within the vehicle, to receive vehicle to infrastructure (V2X) communication, or other wireless data coming from telematics capabilities of the vehicle.

15. The method of claim 12, further comprising determining a speed of the vehicle based on the elapsed time and a known length of the street segment or using a radar/laser speed detector disposed within the first sensor and/or the second sensor and sending a registered owner/driver of the vehicle a citation when the determined speed exceeds a legal speed limit.

16. The method of claim 12, wherein the street segment is a first street segment, a second street segment continues from the first street segment, and the determined time that the vehicle exits the first segment is used as a time that the vehicle enters the second segment.

17. A method for automated on-street parking control, comprising:
receiving, at a central server, a parking request from a mobile device of a user for a specified period of time;
sending a payment request to the mobile device of the user based on the specified period of time;
receiving payment from the mobile device of the user in response to the payment request;
determining a time that a vehicle of the user enters a street segment using a first sensor disposed at a first end of the street segment and/or a second sensor disposed at a second end of the street segment, the second end being an opposite end to the first end;
determining a time that the vehicle exits the street segment using the first sensor and/or the second sensor and calculating an elapsed time as a difference between the determined time that the vehicle exits the street segment and the determined time that the vehicle enters the street segment;
determining whether the elapsed time exceeds the specified period of time; and
assessing a fine to the user only when the elapsed time exceeds the specified period of time.

18. The method of claim 17, wherein the first sensor and/or the second sensor is a camera module, a radar speed detector, a laser speed detector, and/or a radio frequency identification (RFID) detector or is a device configured to use other geolocation and/or identification data transmitted from the vehicle via telematics or vehicle to infrastructure (V2X) communication.

19. The method of claim 17, further comprising advancing a counter of parked vehicles within the street segment by one unit when it is determined that the elapsed time exceeds the specified period of time, which is taken as an indication of the vehicle being parked, and reducing the counter of parked cars when it is determined that the vehicle exits the street segment.

20. The method of claim 19, wherein the counter of parked vehicles, or a measure of parking availability determined therefrom, is shared with one or more drivers of other vehicles.
